(19) United States
(12) Patent Application Publication
(10) Pub. No.: US 2009/0050779 A1
(43) Pub. Date: Feb. 26, 2009

(54) VIBRATION ISOLATION SYSTEM

(75) Inventors: Kimihiko Arimoto, Osaka (JP); Koji Yoshida, Okayama (JP)

Correspondence Address: CANTOR COLBURN, LLP, 20 Church Street, 22nd Floor, Hartford, CT, 06103, US

(73) Assignees: HORIBA, LTD., Kyoto (JP); KURASHIKI KAKO CO., LTD., Okayama (JP)

(21) Appl. No.: 12/195,780

(22) Filed: Aug. 21, 2008

(30) Foreign Application Priority Data
Aug. 21, 2007 (JP) 2007-215308
Jun. 16, 2008 (JP) 2008-157267

(51) Int. Cl. F16M 13/00

(52) U.S. Cl. 248/562; 248/615

(57) ABSTRACT

The present invention may improve an accuracy of a carried position of a semiconductor wafer W to a loading board. The vibration isolation system may be characterized by comprising a base, a loading board that loads a wafer stage on which a semiconductor wafer W is placed, a spring element that is arranged on the base and that supports the loading board and isolates the loading board from a source of vibration, and a positioning mechanism that nullifies the vibration isolation effect of the spring element and that positions the loading board at a predetermined position to the base at a time of placing the semiconductor wafer W on the wafer stage.

### BACKGROUND OF THE INVENTION AND RELATED ART STATE

The present claimed invention relates to a passive vibration isolation system, more specifically a vibration isolation system used for semiconductor manufacturing equipment that processes or inspects a semiconductor wafer.

A conventional passive vibration isolation system has, as shown in the patent document 1, an arrangement wherein a loading board on which a measuring instrument is mounted is supported on a base through multiple air springs. And a vertical position of the loading board is controlled and vibration is isolated by means of the air spring. Due to this arrangement the vibration that the base receives from the placing face can be prevented from being transmitted to the loading board and reactive force received from the wafer stage that moves on the loading board can be absorbed.

However, it is not possible for the passive vibration isolation system having the above arrangement to control the horizontal position of the loading board. As a result, the position of the loading board to the base after vibration is isolated deviates from the position of the loading board to the base before vibration is isolated by about several mm˜several hundred μm.

Meanwhile, a wafer carrier device that carries the semiconductor to the semiconductor manufacturing equipment has an arrangement wherein a carried position is set and the semiconductor wafer is controlled to be carried to the carried position.

Then, the carried position of the semiconductor wafer to the loading board is deviated so that the placed position of the semiconductor wafer placed on the wafer stage fixed to the loading board is also deviated. As a result, the semiconductor wafer is measured at a deviated position, thereby producing a problem that a measurement error is generated.

In addition, it can be conceived that the measurement result of the semiconductor wafer placed at a deviated position is corrected by image processing. However, whereas a deviation of the loading board (semiconductor wafer) is several mm˜several hundred μm, a size of a small wiring circuit formed on the semiconductor wafer is several dozen μm. As a result, there is a problem that it is not possible to correct the measurement error by the image processing on the ground that the wiring circuit is too small to show up in the image.

Furthermore, if the position where the loading board is carried in is deviated from the carried position, the carrier hand of the wafer carrier device might contact a component such as the wafer stage that is loaded on the loading board.

Patent document 1: Japan patent laid-open number 2006-22858

### SUMMARY OF THE INVENTION

The present claimed invention intends to solve all of the problems and its main object is to improve an accuracy of the carried position of the semiconductor wafer to the placing part.

More specifically, the vibration isolation system in accordance with this invention is characterized by comprising a base, a placing part on which a semiconductor wafer is placed, a spring element that is arranged on the base and that supports the placing part and isolates vibration of the placing part, and a positioning mechanism that nullifies the vibration isolation effect of the spring element and that positions the placing part at a predetermined position to the base at a time of placing the semiconductor wafer on the placing part.

With this arrangement, since the placing part is positioned to the base at a time of carrying in the semiconductor wafer, it is possible to improve an accuracy of the carried position of the semiconductor wafer to the placing part. As a result, the measurement error of the semiconductor wafer can be reduced. In addition, it is possible to prevent the carrier hand from making contact with a component of the placing part such as the wafer stage. Furthermore, there is no need of using an expensive control mechanism such as active control, thereby enabling the above-mentioned high accuracy with a low-cost structure.

In addition, it is preferable that the positioning mechanism nullifies the vibration isolation effect of the spring element and positions the placing part at a predetermined position to the base at a time of dismounting the semiconductor wafer from the placing part.

As a concrete embodiment of the positioning mechanism represented is the positioning mechanism that comprises a convex part for positioning arranged on either one of the base and the placing part, a receive part for positioning arranged on either one of the base and the placing part where the convex part for positioning is not arranged, and an air cylinder that uplifts the placing part to the base so as to make the convex part for positioning contact with the receive part for positioning.

In order to position the placing part securely and easily to the base, it is preferable that the positioning mechanism is arranged at three positions between the base and the placing part.

In order to position the placing part to the base with both restraining a vertical movement of the placing part as much as possible and preventing the adverse effect on an optical system it is represented that the positioning mechanism comprising a convex part for positioning arranged on either one of the base and the placing part, a receive part for positioning arranged on either one of the base and the placing part where the convex part for positioning is not arranged, and an actuator that positions the placing part at the predetermined position to the base by moving the convex part for positioning or the receive part for positioning horizontally so as to make the convex part for positioning contact with the receive part for positioning.

In order to simplify the structure of the vibration isolation system, it is preferable that the spring element uses an air spring.

In accordance with this invention having the above-mentioned arrangement, it is possible to improve the accuracy of the carried position of the semiconductor wafer to the placing part.

### BRIEF DESCRIPTION OF THE DRAWINGS

FIG. 1 is a front view of a vibration isolation system in accordance with this embodiment.

FIG. 2 is a side view of the vibration isolation system in this embodiment.

FIG. 3 is a side view of a positioning mechanism in this embodiment.

FIG. 4 is a front view of the positioning mechanism in this embodiment.

FIG. 5 is a view showing a state of carrying a semiconductor wafer in this embodiment.

FIG. 6 is a top view of a vibration isolation system in accordance with another embodiment.

FIG. 7 is a side view of the vibration isolation system in this embodiment.

FIG. 8 is a top view of a vibration isolation system in accordance with a further different embodiment.

FIG. 9 is a top view of a vibration isolation system in accordance with a further different embodiment.

FIG. 10 is a top view of a vibration isolation system in accordance with a further different embodiment.

### DETAILED DESCRIPTION OF THE PREFERRED EMBODIMENTS

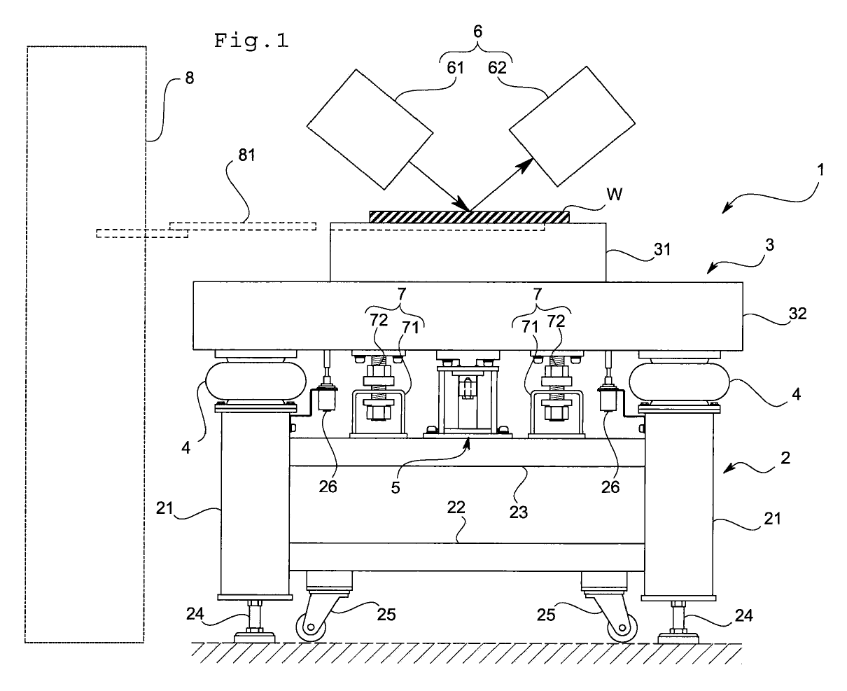

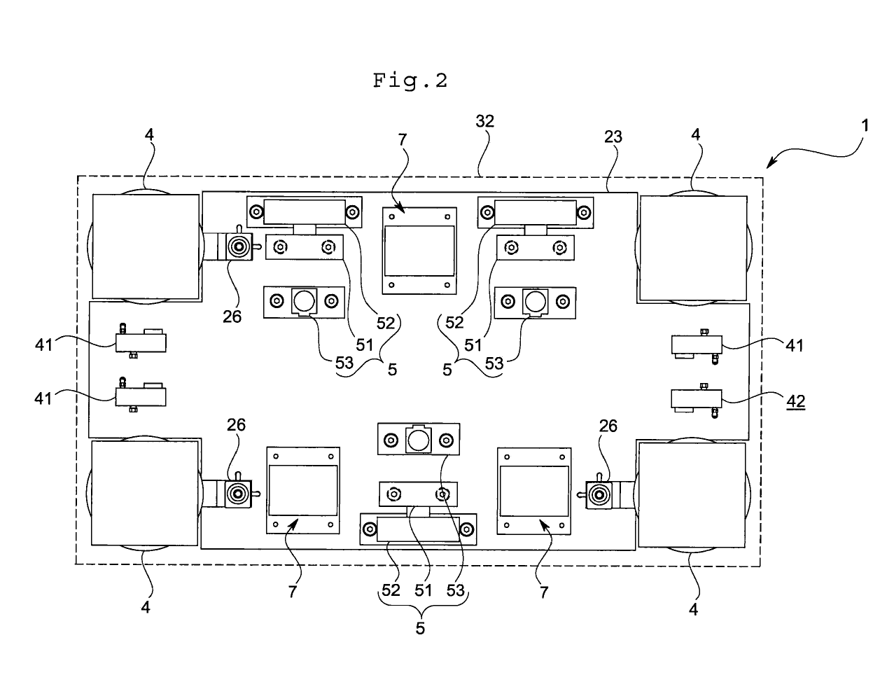

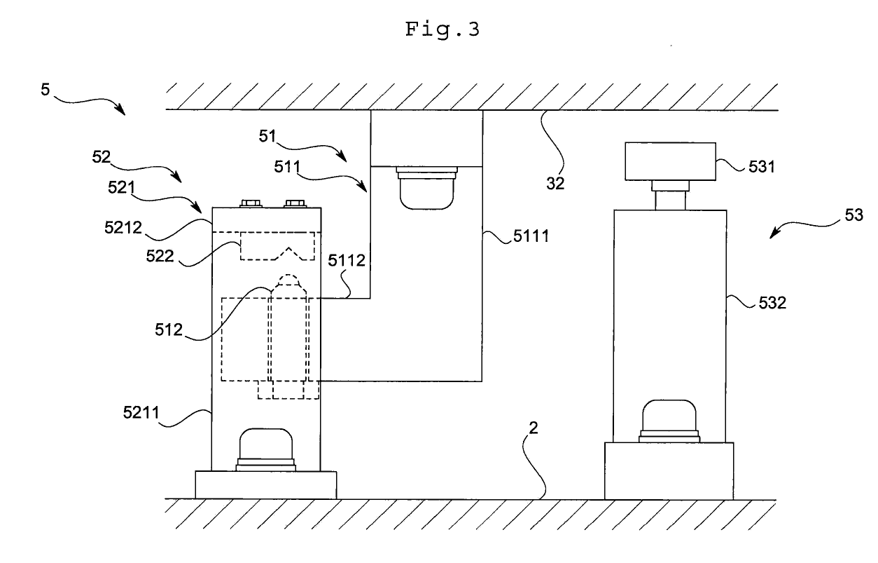

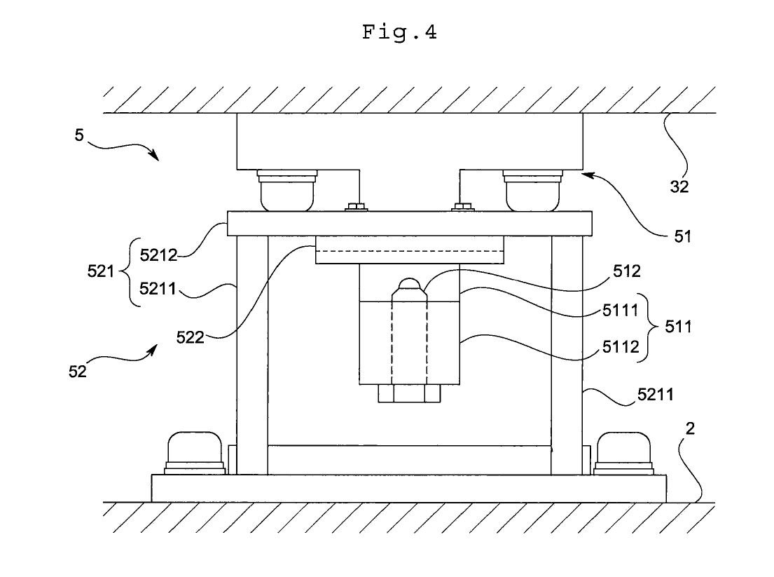

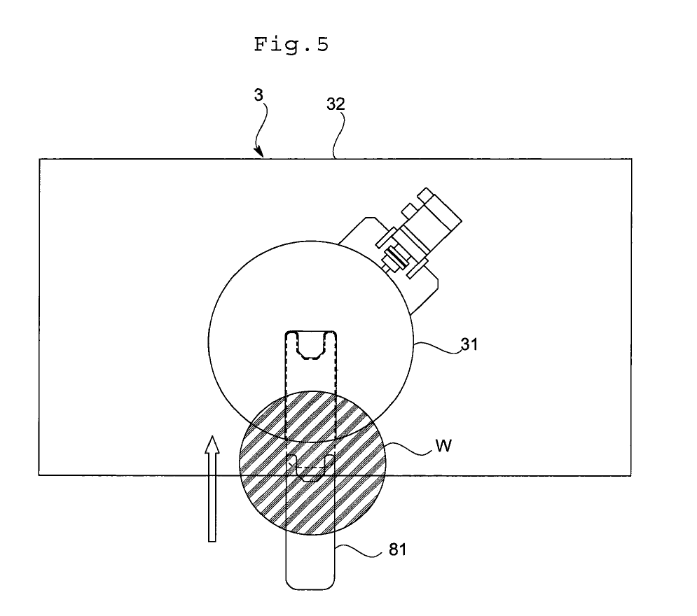

One embodiment of this invention will be explained with reference to drawings. FIG. 1 is a front view of a vibration isolation system 1, and FIG. 2 is a plane view of the vibration isolation system 1. FIG. 3 is a side view of a positioning mechanism 5 and FIG. 4 is a front view of the positioning mechanism 5. FIG. 5 is a view showing a state of carrying a semiconductor wafer.

### <System Configuration>

The vibration isolation system 1 in accordance with this embodiment is used for semiconductor inspection equipment that inspects a film thickness, a foreign material, or presence or absence of defect on a surface of a semiconductor wafer W as being an object to be measured.

Concretely, the vibration isolation system 1 comprises, as shown in FIG. 1 and FIG. 2, a base 2, a placing part 3 on which the semiconductor wafer W is placed, multiple spring elements 4 that are arranged on the base 2 and that support the placing part 3 and isolate the placing part 3 from a source of the vibration, and a positioning mechanism 5 that nullifies the vibration isolation effect of the spring elements 4 and that positions the placing part 3 at a predetermined position to the base 2 at a time of placing the semiconductor wafer W on the placing part 3. A measuring instrument 6 comprises an irradiation optical system 61 that irradiates laser light as being inspection light on the semiconductor wafer W and a detection optical system 62 that detects reflected light or scattered light from the semiconductor wafer W. An optical measuring device having an irradiation optical system and a detection optical system such as an ellipsometer or a scanning probe microscope (SPM) such as, for example, an atom force microscope (AFM) can be represented as the measuring instrument 6. FIG. 1 shows a case of using an optical measuring device.

Each component 2˜5 will be explained.

The base 2 is placed on, for example, an installation surface (floor) in a clean room, and comprises, as shown in FIG. 1, four supporting legs 21, lower beam members 22 that extends horizontally so as to connect each lower part of the adjacent supporting legs 21 and base panel 23 that is arranged horizontally so as to connect each upper part of the supporting legs 21.

A leveler 24 is arranged at a lower end portion of each supporting leg 21. In addition, a caster 25 to transfer the vibration isolation system 1 is arranged on each under surface of the lower beam members 22.

A clamp at time of transfer 7 and the positioning mechanism 5 are fixed to an upper face of the base panel 23 as described later.

The placing part 3 comprises a wafer stage 31 on which the semiconductor wafer W is placed, and a loading board 32 on which the wafer stage 31 and the measuring instrument 6 to inspect the semiconductor wafer W placed on the wafer stage 31 are loaded.

The wafer stage 31 is so arranged to be movable in directions of, for example, X-axis, Y-axis and Z-axis.

The loading board 32 is a lengthy surface table whose plane view is a general rectangle, and in this embodiment, the loading board 32 is made of granite whose thermal capacity is bigger than that of steel and whose figure tolerance is precise. The loading board 32 is arranged on the base 2 through the spring elements 4.

The spring elements 4 are arranged on the base 2 and support the loading board 32 and isolate the loading board 32 from the vibration of the base 2 by insulating the vibration from the base 2. In this embodiment, an air spring is used as the spring element 4.

The air springs 4 are, as shown in FIG. 1, arranged at four corners of the base 2 and the loading board 32. More concretely, the air springs 4 are arranged between upper surfaces of the four supporting legs 21 of the base 2 and the four corners of the loading board 32.

In addition, an electromagnetic valve 41 is arranged on the base 2 to control flow rate of the air as being operating fluid to the air spring 4 (refer to FIG. 2). The air spring 4 is connected with the electromagnetic valve 41 by a tube, not shown in drawings. Furthermore, a control unit (not shown in drawings) to control the electromagnetic valve 41 is arranged. Each of the air springs 4 in this embodiment is fed with the air individually and its internal air pressure is adjusted. The control unit will be explained later.

Furthermore, a level sensor 26 to measure a height of the loading board 32 is arranged on a side face of the supporting leg 21. The level sensor 26 comprises a mechanical switch valve that feeds or discharges the operating fluid to or from the air spring 4 by working with a vertical movement of the loading board 32, and adjusts the air pressure of the air spring 4 so as to stabilize the height of the loading board 32.

In addition, with regard to a relationship of a layout of the air spring 4, the electromagnetic valve 41 and the level sensor 26, the electromagnetic valve 41 is arranged between the air spring 4 and the level sensor 26.

The air pressure in the air spring 4 is adjusted based on the level sensor 26. More concretely, in case that the height of the loading board 32 becomes higher than a predetermined height, the mechanical switch valve of the level sensor 26 is switched to a discharging position so that the air in the air spring 4 is discharged to the atmosphere and the air pressure in the air spring 4 is lowered. Meanwhile, in case that the height of the loading board 32 becomes lower than the predetermined height, the mechanical switch valve of the level sensor 26 is switched to a feeding position so that the air is fed into the air spring 4 and the air pressure in the air spring 4 is increased.

The clamp at time of transfer 7 and the positioning mechanism 5 are arranged between the loading board 32 and the base 2 in the vibration isolation system 1 of this embodiment.

The clamp at time of transfer 7 is to prevent an excessive vibration suppression load applied to the air spring 4 resulting from vibration of the loading board 32 on the base 2 at a time when the vibration isolation system 1 is transferred, and comprises, as shown in FIG. 2, a structure 71 that is fixed to the base 2 and that has a general gate shape in a side view, and a clamp member 72 that is fixed to the loading board 32 and that clamps and fixes an upper wall of the structure 71. In addition, the clamp at time of transfer 7 is arranged at three positions corresponding to apexes of a general equilateral triangle between the base 2 and the loading board 32.

In addition, in case of transferring the vibration isolation system 1, the structure 71 is clamped and fixed by the clamp member 72 and the loading board 32 is fixed to the base 2 so as not to move. In addition, in case of transferring the vibration isolation system 1 to a set position and measuring the semiconductor wafer W, the clamp member 72 is released from the clamped and fixed state so as to allow the loading board 32 to move on the base 2 through the air spring 4.

The positioning mechanism 5 is to position the loading board 32 to the base 2, and is arranged, as shown in FIG. 2, at three positions corresponding to apexes of a general equilateral triangle between the base 2 and the loading board 32.

More concretely, the positioning mechanism 5 comprises, as shown in FIG. 2 through FIG. 4, a first positioning element 51 arranged on the loading board 32, a second positioning element 52 arranged on the base 2 and an air cylinder 53. The air cylinder 53 is not shown in FIG. 4.

The first positioning element 51 comprises, as shown in FIG. 3 and FIG. 4, a first holding body 511 of a generally “L” character shape in cross-sectional view comprising a dropping part 5111 fixed to the under surface of the loading board 32 by means of a screw and a horizontal part 5112 arranged at a lower part of the dropping part 5111, and a convex part for positioning 512 arranged on the horizontal part 5112 of the first holding body 511.

The convex part for positioning 512 is a ball screw that is threadably mounted on an internal thread arranged on the horizontal part 5112 of the first holding body 511 and that is arranged to project from the upper surface of the horizontal part 5112. An external thread whose distal end part is provided with spherical process may be used as the convex part for positioning 512.

The second positioning element 52 comprises a second holding body 521 of a generally gate shape in front view comprising a supporting post part 5211 fixed to the upper surface of the base 2 by means of a screw and a horizontal part 5212 arranged horizontally at an upper part of the supporting post part 5211 and a receive part for positioning 522 of a rectangular shape arranged at an under surface of the horizontal part 5112 of the second holding body 521.

Each of the receive parts for positioning 522 has a different shape respectively according to its positioning mechanism 5. More specifically, in this embodiment, one of the receive parts for positioning 522 has a “V” character shaped groove in its one surface, the other has a inverted cone concave part in its one surface, and the remaining has a flat surface part.

The receive parts for positioning 522 are fixed to the horizontal part 5212 so that each of the “V” character shaped groove, the inverted cone concave part and the flat surface part faces downward. FIG. 3 and FIG. 4 show the positioning mechanism 5 having the receive part for positioning 522 of “V” character shaped groove.

The first positioning element 51 and the second positioning element 52 have an arrangement wherein a horizontal part 5112 of the first holding body 511 having the general “L” character shape is arranged inside the second holding body 521 having the general gate shape and the convex part for positioning 512 and the receive part for positioning 522 are arranged to face each other.

With the above-mentioned arrangement, even though the position (for example, the carried position) of the loading board 32 prior to isolation of the vibration differs from the position of the loading board 32 after isolation of the vibration, the convex part for positioning 512 proceeds along an inner face of the receive part for positioning 522 so that the loading board 32 is positioned in directions of the X-axis and the Y-axis to the base 2 in proportion as the convex parts for positioning 512 of the positioning mechanism 5 fit into the receive part for positioning 522 having the “V” character shaped groove and the receive part for positioning 522 having the inverse cone concave part. In addition, gradient of the loading board 32 to the base 2 is determined by making the convex part for positioning 512 contact with the receive part for positioning 522 having the flat surface part. As a result, the loading board 32 is positioned at the carried position.

The air cylinder 53 is arranged on the upper face of the base 2 and lifts the loading board 32 to the base 2, namely separate the loading board 32 from the base 2 so as to fit the convex part for positioning 512 into the receive part for positioning 522 and to make the convex part for positioning 512 contact with the receive part for positioning 522.

More concretely, the air cylinder 53 comprises a movable part 531 that makes contact with the lower face of the loading board 32 by making a back and forth movement relative to the base 2 and a body part 532 that moves the movable part 531 back and forth by the operating fluid. The air cylinder 53 in this embodiment uses a centralized exhaust system.

In addition, the vibration isolation system 1 comprises an electromagnetic valve 42 that controls the operating fluid in the air cylinder 53 and a control unit (not shown in drawings) that controls the electromagnetic valve 42 to open or close.

The control unit is a general-purpose or dedicated computer comprising a CPU, a memory, and an input-output interface, and controls the air spring 4, the wafer stage 31, the air cylinder 53 of the positioning mechanism 5 of the vibration isolation system 1 and a semiconductor carrier device 8. More concretely, as mentioned above, the control unit controls the electromagnetic valve 41 arranged for the tube connected to the air spring 4. In addition, the control unit controls a driving mechanism of the wafer stage 31. Furthermore, as mentioned, the control unit controls the electromagnetic valve 42 that controls the operating fluid of the air cylinder 53 of the positioning mechanism 5. In addition, the control unit controls a carrier hand 81 of the semiconductor carrier device 8.

The base 2 and the semiconductor carrier device 8 are fixed to the installation surface (floor) in a clean room and the positions where the base 2 and the semiconductor carrier device 8 are installed will not change. However, since the loading board 32 is supported on the base 2 through the air spring 4, a relative position between the loading board 32 and the semiconductor carrier device 8 prior to isolation of the vibration is different from the relative position after isolation of the vibration.

Next, an operation of the vibration isolation system 1 will be explained, in addition to control by the control unit.

The control unit controls the air spring 4, the wafer stage 31, the positioning mechanism 5 of the vibration isolation system 1 and the semiconductor carrier device 8 so that the operation of the vibration isolation system 1 works with the operation of the semiconductor carrier device 8.

The positioning mechanism 5 positions the loading board 32 only at a time when the semiconductor wafer W is carried in and out from the semiconductor inspection equipment. More concretely, the loading board 32 is positioned by the positioning mechanism 5 only at a time when the semiconductor wafer W is placed on the wafer stage 31 and at a time when the semiconductor wafer W is removed from the wafer stage 31.

More concretely, the positioning operation of the vibration isolation system 1 in this embodiment is conducted both prior to and after the measurement of the semiconductor wafer W with the following procedures; “transferring of the wafer stage 31”→“positioning of the loading board 32”→“carrying of the semiconductor wafer W”. Details will be explained below.

Prior to positioning of the loading board 32 to the base 2, first the control unit controls the driving mechanism of the wafer stage 31 so that a placing stage of the wafer stage 31 is moved to a predetermined position on the loading board 32. “The predetermined position” here is a position of the placing stage that has been previously determined at a time when the semiconductor wafer W is placed on the wafer stage 31.

At this time, the positioning mechanism 5 is in a released state and the vibration isolation function of the vibration isolation system 1 is “ON”. With this state, the vibration of the loading board 32 accompanied by moving the wafer stage 31 is isolated. As a result of this, the loading board 32 stands still after vibrating for a certain period of time.

In this embodiment, in order to determine whether the loading board 32 stands still or not, the predetermined position (for example, the convex part for positioning 512 of the positioning mechanism 5 arranged under the loading board 32) on the loading board 32 is measured by a sensor and its measurement signal is received by the control unit.

In a state that the loading board 32 stands still, the position of the wafer stage 31 on the loading board 32 is at a controlled position, however, the position of the wafer stage 31 to the base 2 is different from the predetermined carried position.

Then the control unit judges whether the loading board 32 stands still or not based on the measurement signal from the sensor. In case that the control unit judges that the loading board 32 stands still, the control unit closes the electromagnetic valve 41 so as to seal the air spring 4. As a result, even though the loading board 32 is lifted by the air cylinder 53, the air in the air spring 4 is not discharged due to the level sensor 26. On a condition that the air in the air spring 4 is discharged when the loading board 32 is lifted by the air cylinder 53, there is a problem that it takes time for the loading board 32 to be restored at the original position because the loading board 32 goes down deeply at a time when the air cylinder 53 is released.

Next, the control unit controls the air cylinder 53 of the positioning mechanism 5 and positions and fixes the loading board 32 to the base 2. More concretely, the control unit controls the electromagnetic valve 42 connected to the air cylinder 53 so as to uplift the loading board 32.

This uplifts the loading board 32 to the base 2, and then the convex part for positioning 512 arranged on the loading board 32 fits into and makes contact with the receive part for positioning 522 arranged on the base 2 so that the loading board 32 is positioned to the base 2. More concretely, as shown in FIG. 5, the wafer stage 31 mounted on the loading board 32 is positioned at the carried position of the carrier hand 81 of the semiconductor carrier device 8.

It may be so arranged that time considered to be time when the loading board 32 stands still is previously determined and the control unit controls the air cylinder 53 of the positioning mechanism 5 after the time has passed without receiving the measurement signal.

As mentioned, since the loading board 32 is positioned and fixed after the wafer stage 31 is transferred, it is possible to prevent malfunction of the positioning mechanism 5 resulting from transferring the wafer stage 31. More specifically, in case that the wafer stage 31 is driven while the positioning mechanism 5 is operated, there is a problem that the convex part for positioning 512 fails to fit into the receive part for positioning 522 sufficiently because the loading board 32 vibrates and an excessive load is applied to the convex part for positioning 512 and the receive part for positioning 522 of the positioning mechanism 5. However, with the above-mentioned arrangement, it is possible to prevent the problem. In addition, it is possible to preferably prevent breakage of the positioning mechanism due to abrasion accompanied by vibration. The same effect can be produced if the positioning mechanism 5 is operated while the loading board 32 vibrates.

Later, the control unit controls the semiconductor carrier device 8 so that the semiconductor wafer W is transferred to the semiconductor inspection equipment by the use of the carrier hand 81 and placed on the wafer stage 31. After the semiconductor wafer W is carried in, the control unit controls the control valve 42 so as to cease the air cylinder 53, and then opens the electromagnetic valve 41.

In case of carrying out the semiconductor wafer W, also as mentioned above, the following procedures are conducted; “transferring of the wafer stage 31”→-“positioning of the loading board 32”→“carrying of the semiconductor wafer W”.

At a time of carrying in and out the semiconductor wafer W (the air cylinder 53 is operated), the convex part for positioning 512 fits into and makes contact with the receive part for positioning 522 so that the loading board 32 is fixed to the base 2, and the vibration isolation function of the air spring 4 is in a halted state (nullified).

Meanwhile, at a time of measuring the semiconductor wafer W, the air cylinder 53 is halted and the vibration isolation function of the air spring 4 is in an activated state (validated).

### EFFECT OF THIS EMBODIMENT

In accordance with the vibration isolation system 1 in accordance with this embodiment having the above-mentioned arrangement, since the loading board 32 is positioned to the base 2 at the time of carrying in the semiconductor wafer W, it is possible to improve positional reproducibility of the loading board 32, thereby improving the accuracy of the carried position of the semiconductor wafer W to the loading board 32, especially, the accuracy of the placed position of the semiconductor wafer W to the wafer stage 31. As a result, it is possible to reduce a measurement error of the semiconductor wafer W.

In addition, since the loading board 32 is positioned to the base 2 while carrying in and out the semiconductor wafer W, it is possible to prevent the carrier hand 81 from contacting a component such as the wafer stage 31. Furthermore, there is no need of using an expensive control mechanism such as active control, and it is possible to realize a high accuracy with a low-cost arrangement. Furthermore, with this vibration isolation system 1, it is possible to conduct measurement of the semiconductor wafer W with a high accuracy.

### OTHER MODIFIED EMBODIMENT

The present claimed invention is not limited to the above-mentioned embodiment. The same numerical code is given to the same component corresponding to that of the above-mentioned embodiment.

For example, only the air cylinder 53 is used in order to uplift the loading board 32 to the base 2 in the above-mentioned embodiment, however, the loading board 32 may be uplifted by the use of the air cylinder 53 and the air spring 4. More specifically, the loading board 32 may be lifted up by operating the air cylinder 53 and increasing the air pressure of the air spring 4 at a time of carrying in the semiconductor wafer W to the measuring instrument 6 and carrying out the semiconductor wafer W from the measuring instrument 6. With this arrangement, the same effect as that of this invention can be produced by the use of a low-cost air cylinder having a small volume with a simple arrangement.

A position or a number of the positioning mechanism 5 is not limited to the above-mentioned, and may be selected appropriately.

Furthermore, the convex part for positioning 512 is arranged on the loading board 32 and the receive part for positioning 522 is arranged on the base 2 in the above-mentioned embodiment, however they may be arranged contrary.

In addition, the loading board 32 is separated from the base 2 in order to make the convex part for positioning 512 contact with the receive part for positioning 522 in the above-mentioned embodiment, however, the loading board 32 may be moved to approach (be closer to) the base 2 in order to make the convex part for positioning 512 contact with the receive part for positioning 522. More specifically the loading board 32 may be separated from the base 2 or the loading board 32 may be moved to approach the base 2 in order to make the convex part for positioning 512 contact with the receive part for positioning 522.

In addition, the wafer stage 31 is moved on the loading board 32 in the above-mentioned embodiment, however, the measuring instrument 6 may be moved. More concretely, the measuring instrument 6 may be moved so as to be adjusted to the measuring position of the semiconductor wafer W by integrating the wafer stage 31 and the loading board 32.

The spring element in the above-mentioned embodiment uses the air spring, however, it may use vibration insulation rubber or other spring.

In addition, in case that the semiconductor inspection equipment has multiple semiconductor wafer carrying ports, it is preferable that the control unit controls the air spring 4, the wafer stage 31, the positioning mechanism 5 and the semiconductor carrier device 8 as follows.

More specifically, in case of carrying out the semiconductor wafer W from a certain carrying port, the wafer stage 31 is moved by releasing the positioning mechanism 5 during a period from time after the carrier hand 81 uplifts the semiconductor wafer W until the semiconductor wafer W is carried out outside of the semiconductor inspection equipment from the carrying port. Then the wafer stage 31 is moved to the carried position where the semiconductor wafer W is carried in and then the loading board 32 is positioned by means of the positioning mechanism 5. With this arrangement, it is possible to shorten time to require for a series of operation to carry in and out the semiconductor wafer W.

In addition, in case of carrying in the semiconductor wafer W from a certain carrying port, it is also possible that the wafer stage 31 is moved by releasing the positioning mechanism 5 so as to be located at an initial position where the semiconductor wafer W is measured and then the measurement is initiated during a period from time after the carrier hand 81 places the semiconductor wafer W on the wafer stage 31 until the carrier hand 81 is carried out outside of the semiconductor inspection equipment.

If the wafer stage 31 is moved by releasing the positioning mechanism 5 at a moment when the semiconductor wafer W is lifted up or at a moment when the semiconductor wafer W is placed on a placing stage, there is a problem from the viewpoint of safety that the carrier hand 81 might make contact with the placing stage of the wafer stage 31. However, it is possible to solve this problem by designing the dimension optimally with taking into consideration of the clearance.

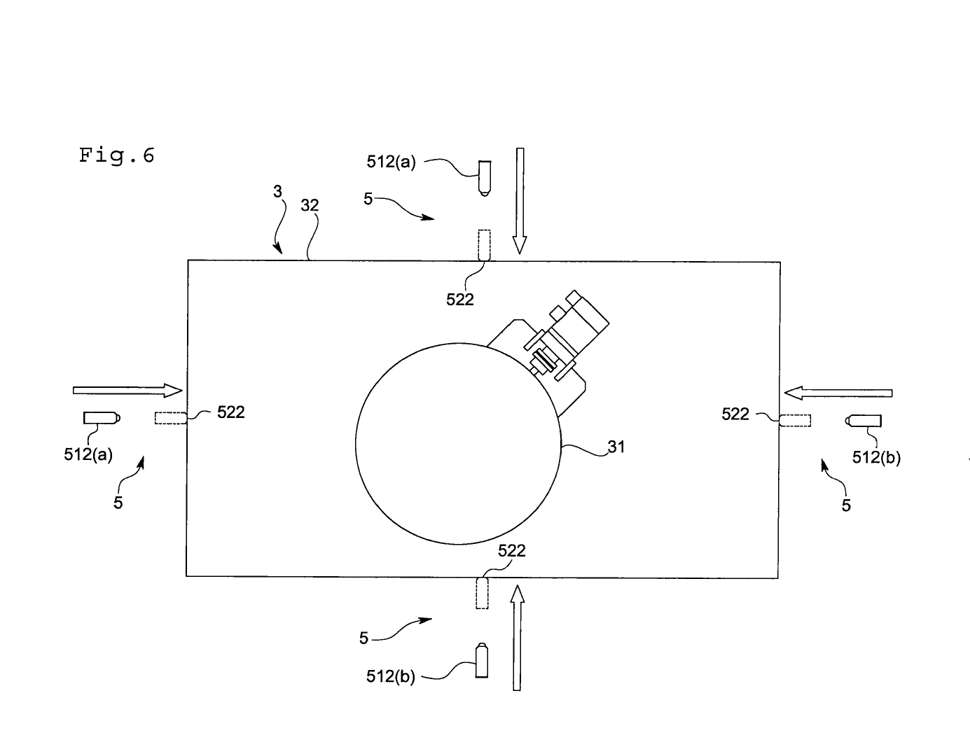

Next, another embodiment will be explained. In the above-mentioned embodiment, the placing part 3 is positioned to the base 2 by lifting up the loading board 32 to the base 2 with the air cylinder 53 making a back and forth movement in the Z direction as being the vertical direction so as to make the receive part for positioning 522 contact with and fit over the convex part for positioning 512. In the second embodiment, the placing part 3 is positioned to the base 2 by moving the loading board 32 to the base 2 horizontally as shown in FIG. 6. More concretely, the vibration isolation system 1 of this embodiment comprises the receive parts for positioning 522 arranged on each side face of the loading board 32, the convex parts for positioning 512(a), 512(b) arranged on the base 2, and an actuator (not shown in drawings) that moves the convex part for positioning 512(a), 512(b) horizontally until the convex part for positioning 512(a), 512(b) makes contact with the receive part for positioning 522 and is fittingly inserted into the receive part for positioning 522 without bumpy movements so as to position the placing part 3 to the base 2 at a predetermined position.

Each of the receive parts for positioning 522 is a reverse circular conic concave part arranged at a center part of each of the four side faces of the loading board 32.

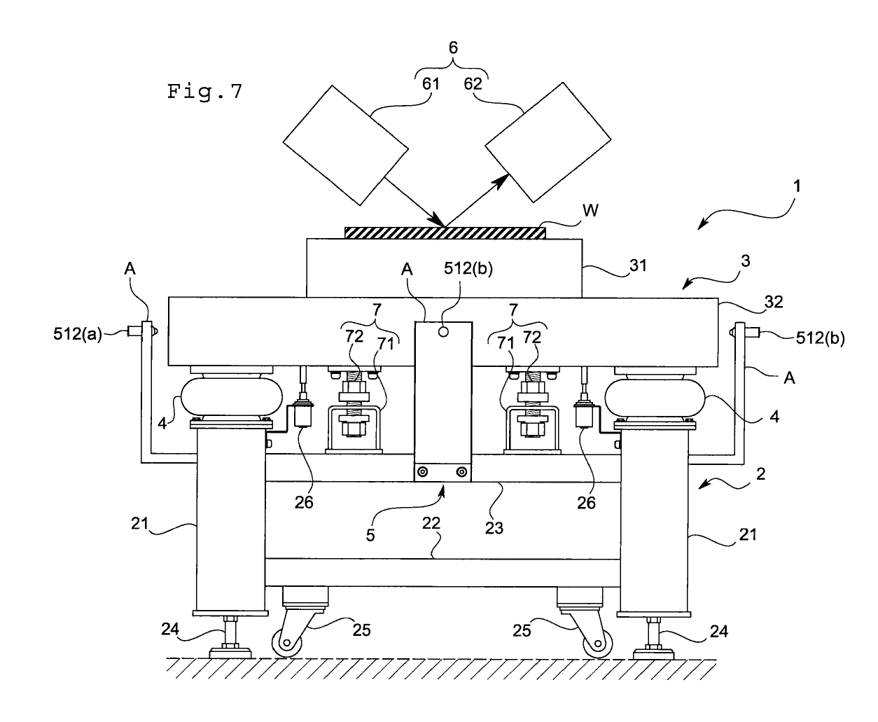

Each of the convex parts for positioning 512(a), 512(b) is a bar-shaped body having a spherical distal end and arranged to face each other respectively. More specifically, each of the convex parts for positioning 512(a), 512(b) is arranged to clamp both side faces of the loading board 32 in a longitudinal direction and a lateral direction. As shown in FIG. 7, the convex parts for positioning 512 are supported by the base panel 23 of the base 2 by means of the mounting member A, and arranged to make a back and forth movement toward the receive parts for positioning 522. One convex part for positioning 512(a) among the convex parts for positioning 512(a), 512(b) is so arranged to move from an evacuating position where the convex part for positioning 512(a) does not contact the receive part for positioning 522 by a predetermined distance. Other convex part for positioning 512(b) is so arranged to move until it reaches a position where the loading board 32 is clamped so as to be fixed by a pair of the convex parts for positioning 512(a), 512(b).

A positioning operation after vibration is isolated will be explained. Four convex parts for positioning 512 are moved horizontally by the actuator so that each of the convex parts for positioning 512 approaches each of the opposed receive parts for positioning 522 respectively. Two convex parts for positioning 512(a) among four convex parts for positioning 512 move by the predetermined distance from the evacuating position, which does not move relative to the floor and which does not contact the convex part for positioning 512 even though the placing part 3 moves horizontally resulting from isolation of the vibration, and then halt. The other convex parts for positioning 512(b) move to approach the receive parts for positioning 522 until they contact the receive parts for positioning 522 and then push loading board 32 against the above-mentioned halted convex parts for positioning 512(a). The halted convex parts for positioning 512(a) and the moving convex parts for positioning 512(b) are fittingly inserted into the receive parts for positioning 522, and the moving concave parts 512(b) are also halted at a time when the convex parts for positioning 512(a), 512(b) fit into the receive parts for positioning 522 without bumpy movement, and then the positioning is terminated.

As mentioned above, it is possible to position the loading board 32 horizontally and vertically on the basis of the convex parts for positioning 512(a) having an arrangement to move from the evacuating position by the predetermined distance and to invalidate the vibration isolation function because the loading board 32 is fixed to the base 2. In addition, since the loading board 32 can be positioned just by moving the loading board 32 generally horizontally, it is possible to curb a vertical movement that exercises an influence on optical systems such as the measuring instrument 6 arranged on the loading board 32.

The convex parts for positioning 512 are moved horizontally in order to position the placing part 3 to the base 2 in this embodiment, however, the positioning may be conducted by moving the placing part 3 by the use of the actuator so as to fittingly insert the convex parts for positioning 512 into the receive parts for positioning 522 without a bumpy movement.

The base specified in this specification is not limited to the base 2 described in each embodiment. For example, the convex parts for positioning 512 may be arranged on a pedestal that is arranged around the vibration isolation system 1 during a process of inspecting semiconductors, that is fixed to the floor and that accommodates the measuring instrument of semiconductors or the vibration isolation system.

In addition, the receive parts for positioning 522 may be arranged on the base 2 and the convex parts for positioning 512 may be arranged on the placing part 3. Furthermore, multiple receive parts for positioning 522 may be arranged on one side face of the loading board 32 and multiple convex parts for positioning 512 may be arranged to correspond to the receive parts for positioning 522. For example, two receive parts for positioning 522 may be arranged on a side face of the loading board 32.

A shape of the receive part for positioning 522 is not limited to the reverse circular conic concave part. The receive part for positioning 522 may be of a “V” character shaped groove that extends vertically and a “V” character shaped groove that extends horizontally so that horizontal and vertical positioning can be conducted.

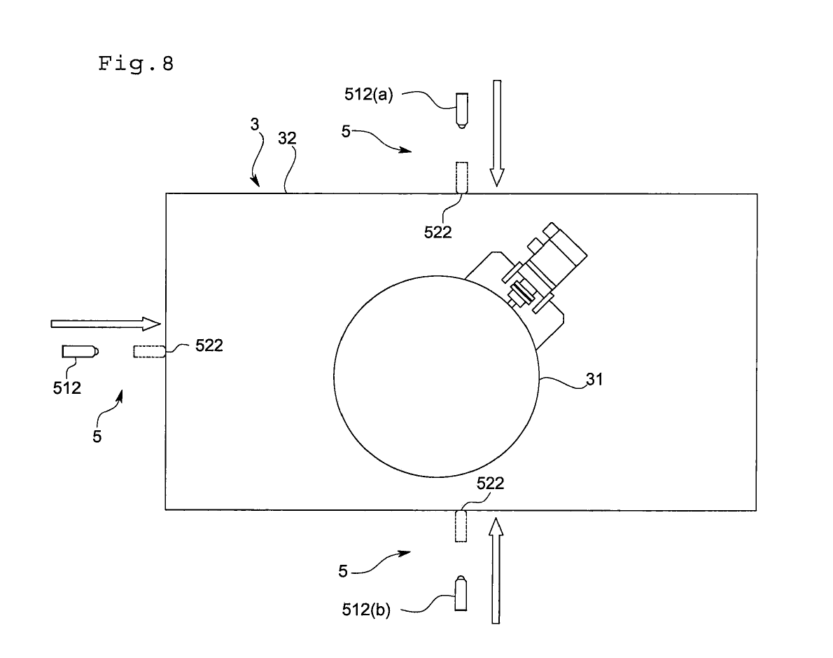

Four groups of the convex parts for positioning 512 and the receive parts for positioning 522 are used to position the placing part 3 to the base 2 in this embodiment, however, three groups of the convex parts for positioning 512 and the receive parts for positioning 522 may be used to position the placing part 3. As shown in FIG. 8, two groups of the convex parts for positioning 512(a), 512(b) and the receive parts for positioning 522 arranged to clamp side faces of the loading board 32 laterally, and one group of the convex part for positioning 512 and the receive part for positioning 522 arranged on one of the side faces in a longitudinal direction of the loading board 32 may be arranged. First, the loading board 32 is positioned horizontally and vertically by means of two groups of the positioning mechanisms 5 arranged laterally. In this state, since the loading board 32 still has freedom of rotation around a rotational axis in a lateral direction, the convex part for positioning 512 arranged in the longitudinal direction is pushed against the receive part for positioning 522 so that the loading board 32 locates horizontally.

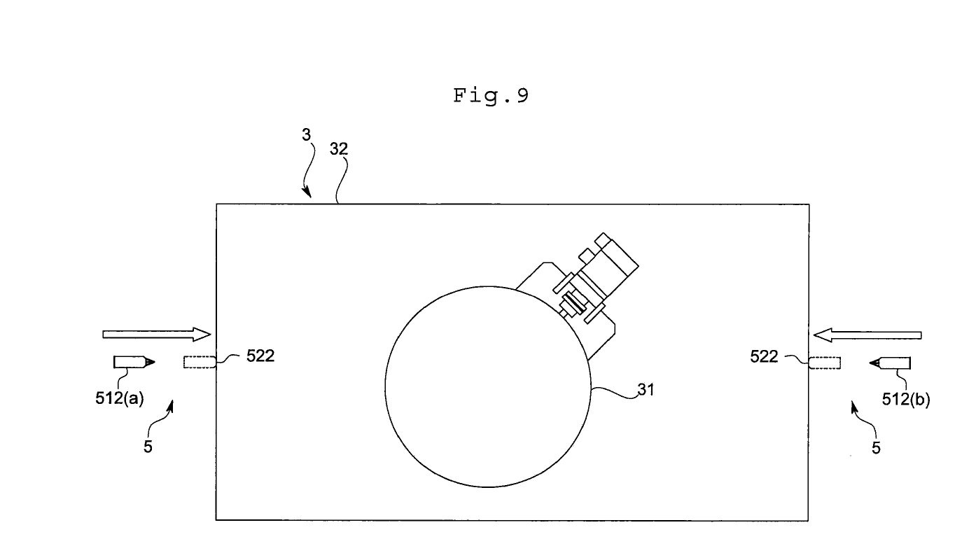

In addition, two groups of the positioning mechanisms 5 may be arranged to conduct positioning. For example, the convex parts for positioning 512 having a poly pyramid shaped distal end may be arranged to clamp the side faces of the placing part 3 in a longitudinal direction and the receive parts for positioning 522 having a poly pyramid shaped groove may be used. As shown in FIG. 9, since the convex part for positioning 512 having a quadrangular pyramid shaped-distal end is so arranged to be fittingly inserted into the receive part for positioning 522 having a quadrangular pyramid shaped groove without a bumpy movement, it is possible to position the placing part 3 horizontally and vertically to the base 2 at a predetermined position.

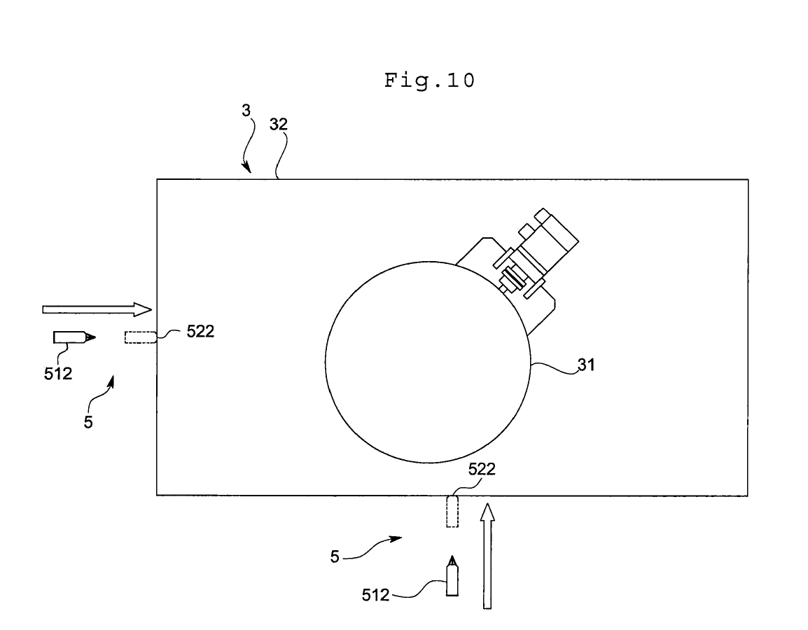

In addition, as shown in FIG. 10, also in case that the receive parts for positioning 522 are arranged on the adjacent side faces of the loading board 32 so as not to clamp the placing part 3, it is possible to position the placing part 3 at a predetermined position by fittingly inserting the convex parts for positioning 512 into the receive parts for positioning 522 generally at the same time so as to prevent the placing part 3 from escaping in a direction to which the placing part 3 is pushed.

Furthermore, a vibration suppression mechanism such as a counter weight may be arranged between the wafer stage 31 and the loading board 32 to reduce vibration at the time of initiating and ceasing moving of the wafer stage 31. In this case, since the vibration at the time of initiating and ceasing moving of the wafer stage 31 can be reduced and the position where the loading board 32 locates after the vibration is isolated can be prevented from moving to the base 2 significantly, it is possible to make the “V” character shaped groove and the reverse circular conic concave part of the receive part for positioning 512 smaller. Contrary, since there is the positioning mechanism 5, it is possible to facilitate positioning of the loading board 32 in the directions of the X axis and the Y axis at a time when the vibration isolation system 1 is halted without a high level of the vibration isolation function of the wafer stage 31, thereby lowering the cost.

In addition, a part or all of the above-mentioned embodiment or the modified embodiment may be appropriately combined, and it is a matter of course that the present claimed invention is not limited to the above-mentioned embodiment and may be variously modified without departing from a spirit of the invention.

1. A vibration isolation system comprising
a base,
a placing part on which a semiconductor wafer is placed,
a spring element that is arranged on the base and that supports the placing part and isolates vibration of the placing part, and
a positioning mechanism that nullifies the vibration isolation effect of the spring element and that positions the placing part at a predetermined position to the base at a time of placing the semiconductor wafer on the placing part.

2. The vibration isolation system described in claim 1, wherein
the positioning mechanism nullifies the vibration isolation effect of the spring element and positions the placing part at the predetermined position to the base at a time of dismounting the semiconductor wafer from the placing part.

3. The vibration isolation system described in claim 1, wherein
the positioning mechanism comprises
a convex part for positioning arranged on either one of the base and the placing part,
a receive part for positioning arranged on either one of the base and the placing part where the convex part for positioning is not arranged, and
an air cylinder that uplifts the placing part to the base so as to make the convex part for positioning contact with the receive part for positioning.

4. The vibration isolation system described in claim 1, wherein
the positioning mechanism is arranged at three positions between the base and the placing part.

5. The vibration isolation system described in claim 1, wherein
the positioning mechanism comprises
a convex part for positioning arranged on either one of the base and the placing part,
a receive part for positioning arranged on either one of the base and the placing part where the convex part for positioning is not arranged, and
an actuator that positions the placing part at the predetermined position to the base by moving the convex part for positioning or the receive part for positioning horizontally so as to make the convex part for positioning contact with the receive part for positioning.

6. The vibration isolation system described in claim 1, wherein
the spring element uses an air spring.
